(19) United States
(12) Patent Application Publication
(10) Pub. No.: US 2007/0177568 A1
(43) Pub. Date: Aug. 2, 2007

(54) Message system

(76) Inventors: Steven Terrell Clontz, Singapore (SG); Brian Cheng-Jean Chen, Chicago, IL (US)

Correspondence Address: WELLS ST. JOHN P.S., 601 W. FIRST AVENUE, SUITE 1300, SPOKANE, WA, 99201, US

(21) Appl. No.: 10/565,312

(22) PCT Filed: Jul. 16, 2004
(86) PCT No.: PCT/SG04/00214

§ 371 Date: Feb. 23, 2007

(30) Foreign Application Priority Data
Jul. 18, 2003 (SG) 200303726-4

(51) Int. Cl. H04J 3/24

(52) U.S. Cl. 370/349

(57) ABSTRACT

A method of two-way communication between a web browser and a mobile telecommunication device (13) including steps of; accessing a web-site via a computer (1), sending a message to a mobile telecommunication device (13) from the web-site, and at a message server (4) capturing the IP address and port number of the computer (1), storing the temporary phone number, IP address of the computer (1) and port number of the computer (1) in a database (5), and sending the message to the mobile telecommunication device (13) with the temporary phone number.

### FIELD OF INVENTION

The invention relates to a system for communication between an Internet browser and a mobile telecommunication device.

### BACKGROUND

Currently mobile phone subscribers can send and receive SMS (short message service) or MMS (multimedia message service) messages to and from other mobile phone users. This two-way messaging is only available to mobile phone subscribers through mobile telecommunication devices.

One-way messaging is also available between a sending party using an Internet enabled device via a web browser and a receiving mobile phone subscriber. The sender of the message uses a telecommunication service provider to send the SMS or MMS message to the mobile telecommunication device subscriber. No reply can be sent to the Internet browser from the mobile telecommunication device.

Several systems have been proposed to overcome this problem.

U.S. Pat. No. 6,178,331 describes a bi-directional multiplexing messaging gateway for wireless devices such as mobile phones. The patent describes that when a message is sent from an outside email source the gateway may create a new temporary MSISDN number associated with the reply address before sending the message and reply MSISDN to the mobile phone. The user of the mobile phone can then reply to the message and the MSISDN is sent back to the gateway with the reply message. The gateway then maps the MSISDN back to the address of the original sender. However, this system requires that the sender have an email address. The system does not work when the sender doesn't have an email address.

U.S. Pat. No. 6,085,100 describes a system for sending and receiving short messages. When an external device is used to send an SMS to a mobile phone, the SMS is first routed through a gateway. The gateway stores in a database the address to which the SMS is being sent, a time stamp and the address of the external device. When the mobile phone user replies to the message it is sent back to the gateway with the timestamp. The gateway uses a combination of the time stamp and the destination address of the mobile phone to search the database and find the address of the external device. The reply is then sent on to the external device. This system is more complex and relies on the use of date and time stamping to identify the originating device. If two or more messages are sent to the same mobile subscriber within a second the system will not be able to determine to which sender to a response should be directed. Another disadvantage is that the temporary source address, as a combination of Gateway Application address, date, and time stamp could be very long. The address may be too long for the SMS message signal to accommodate and will not work for Internet SMS.

PCT patent publication WO 02/058356 describes a method for sending MMS messages between mobile phones via the Internet. The originating mobile phone is connected to the internet via a public land-mobile network (PTMN). Men the originating mobile phone sends an MMS message to a receiving mobile phone, the message is first routed to an MMS server. The message lists the receiving mobile phone by its MSISDN number (essentially the phone number of the mobile phone). The message server sends a notification message to a PAP server. The PAP server determines whether the receiving mobile phone is currently communicating with the Internet. If the receiving device is communicating with the Internet the PAP server sends the receiving mobile notification that there is an MMS message at the MMS server. If the receiving device is communicating with the Internet via a different PTMN than that which is being used by the originating mobile phone, or the receiving mobile phone is not communicating with the Internet, the MMS server sends an SMS to the receiving mobile using the MSISDN number of the receiving mobile. This invention will only work between two mobile devices with existing MSISDN numbers. It is not suitable for communication between mobile phones and web browsers.

### SUMMARY OF INVENTION

It is the object of this invention to provide a method of two-way communication between a web browser and a mobile telecommunication device or to at least provide the public with a useful choice.

In broad terms in one aspect the invention comprises a method of two-way communication between a web browser and a mobile telecommunication device including the steps of; accessing a web-site via a computer, sending a message to a mobile telecommunication device from the web-site, and at a message server capturing the IP address and port number of the computer, assigning a temporary phone number to the IP address and port number of the computer, storing the temporary phone number, IP address of the computer and port number of the computer in a database, and sending the message to the mobile telecommunication device with the temporary phone number.

Preferably the message server further includes the step of capturing the receiving mobile telecommunication device number.

Preferably the message server further includes the step of sending an acknowledgement to the web-site. The acknowledgement may include instructions to keep the web-site open in order to receive replies from the mobile telecommunication device.

In broad terms in another aspect the invention comprises a message server arranged to capture an IP address and port number of a computer sending a message to a mobile telecommunication device via a web-site, capture the message sent by the computer, assign a temporally phone number to the IP address and port number of the computer, store the temporary phone number, IP address of the computer and port number of the computer in a database, and send the message to the mobile telecommunication device with the temporary phone number.

Preferably the message server is further arranged to capture the receiving mobile telecommunication device number.

Preferably the message server is further arranged to send an acknowledgement to the web-site. The acknowledgement may include instructions to keep the web-site open in order to receive replies from the mobile telecommunication device.

Preferably the web site is provided by a telecommunication service provider.

A set number of temporary phone numbers may be available for assigning by the message server.

The message server may further be arranged so that upon receipt of a message from a mobile telecommunication device sent to a temporary phone number of the message server, it will capture the message, temporary phone number, and the receiving mobile telecommunication device number, use the database to match the temporary phone number to a computer IP address and port number and the receiving mobile telecommunication device number, and send the message to the computer with the matching IP address and port number.

### BRIEF DESCRIPTION OF DRAWINGS

The invention including a preferred form thereof will be further described with reference to the accompanying figure in which;

FIG. 1 shows a communication system for communication between a web site and a mobile telecommunication device.

### DETAILED DESCRIPTION

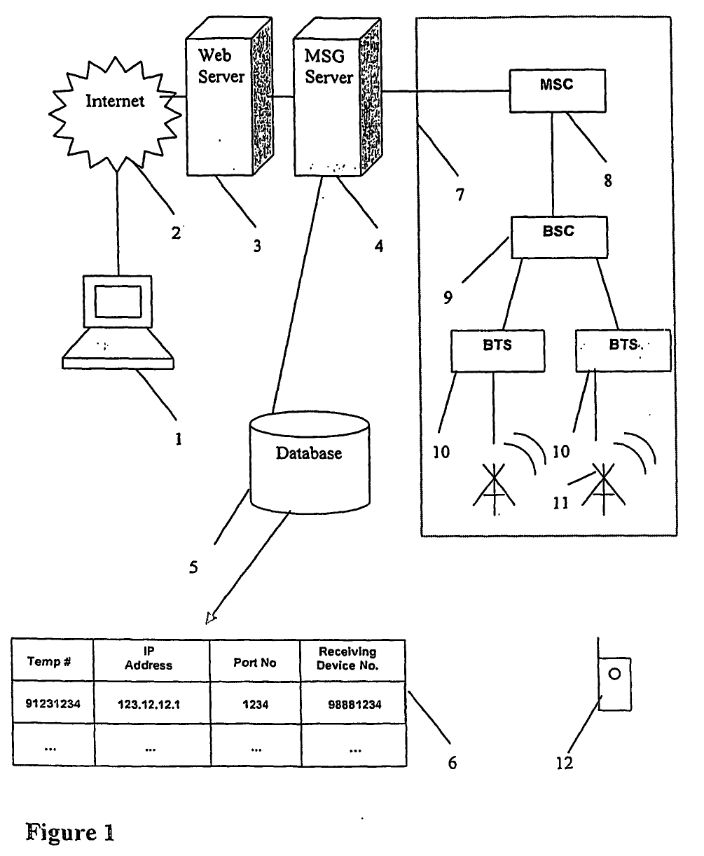

FIG. 1 shows a communications system of the invention. The communications system includes a computer 1 connected to the Internet 2. Web server 3 is also connected to the Internet. Web server 3 is further connected to message server 4. Message server 4 includes database 5 and translation table 6. Message server 4 is connected to telecommunication network 7. Telecommunication network 7 includes Mobile Switching Centres (MSC) 8, Base Station Controllers (BSC) 9, Base Transceiver Stations (BTS) 10 and cell phone towers 11.

A user wishing to send a message via the Internet to a mobile telecommunication device accesses the Internet 2 using computer 1. The user accesses a web site via the internet. The web site may be stored on web server 3. Using the web site the user types a message to be sent to a mobile telecommunication device as well as the phone number of the mobile telecommunication device. When the user has finished waiting the message the user selects a send function on the web site. The message is then sent from the web server 3 to message server 4.

Upon receipt of a message from web server 3, message server 4 captures the IP address and port number of computer 1. Database 5 and translation table 6 are queried to check if any temporary phone number has been assigned to the captured IP address and port number. If no temporary phone number has been assigned to the captured IP address and port number a temporary phone number is then assigned. The temporary phone number, IP address of computer 1 and port number of computer 1 are then stored in message database 5 and translation table 6.

In one preferred embodiment message server 4 also captures the receiving mobile telecommunication device number and stores this information with the captured IP address and port number of the originating device. In this embodiment database 5 and translation table 6 are queried to check if any temporary phone number has been assigned to the captured IP address, port number and receiving mobile telecommunication device number.

In the preferred embodiment if there is no temporary phone number assigned to the captured IP address, receiving mobile telecommunication de-%ice number and port. number a temporary phone number is assigned and the IP address and port number are stored along with the phone number of the receiving mobile telecommunication device.

In a further alternative embodiment the message server 4 captures the IP address and port number of computer 1 and the receiving mobile telecommunication device number. In this embodiment database 5 and translation table 6 are queried to check if any temporary phone number has been assigned to the captured IP address and port number. In this embodiment the receiving mobile telecommunication device number is captured but not used to determine whether a temporary phone number has been assigned to the originating computer 1.

If there is no temporary phone number assigned to the captured IP address and port number a temporary phone number is then assigned and the IP address and port number are stored along with the phone number of the receiving mobile telecommunication device.

The message received by message server 4 is then sent to telecommunication network 7 with the assigned temporary phone number the temporary phone number is currently assigned to the captured IP address and port number (and in the preferred embodiment the receiving mobile telecommunication device number) and the message is sent to telecommunication device 12 with the currently assigned temporary phone number.

The message server may also send an acknowledgement to computer 1 that the message has been sent and that the web-site should be kept open in order to receive any reply from the mobile telecommunication device.

When the message server 4 is set up a number of telephone numbers may be assigned to the message server by a telecommunication service provider. For example the message server may be provided with a sequence of 10,000 telephone numbers. Each of these telephone numbers can be assigned as a temporary telephone number for a device attached to the Internet. The number of temporary telephone numbers assigned to the message server may be based on the estimated number of messages simultaneously using the message server and the estimated average length of use of a temporary telephone number by an Internet device.

If all the temporary telephone numbers have been assigned the message server may search the database and find a temporary telephone number that can be reassigned. Assigning a temporary telephone number may be on the basis of reassigning the telephone number that was the earliest to be assigned. Alternatively the database may include a time stamp of the latest time a message was sent either to or from a computer IP address and port number and receiving mobile telecommunication device number assigned to a temporary telephone number. The message server 4 may then select the temporary telephone number with the longest time since last use on the assumption that it is no longer in use. Alternatively, all temporary telephone numbers exceeding a pre-specified time limit, for example 24 hours, will be reused.

To assist in the availability of temporary telephone numbers, when a user using a web site to send messages to a mobile device closes the web site a message may be sent to the message server that the temporary phone number is no longer needed and the temporary phone number may be added to the pool of available temporary phone numbers.

Telecommunication network 7 delivers the message and temporary phone number to mobile telecommunication device 12. The user of the mobile telecommunication device can then reply to the message using the temporary phone number as the user will normally do with the current SMS or MMS procedure.

When the user of the mobile telecommunication device replies to the message, the message from the mobile telecommunication device passes through telecommunication network 7 to MSC 8. MSC 8 recognises the phone number to which the message is sent as belonging to message server 4 and directs the message to message server 4.

Message server 4 looks up the temporally phone number using message database 5 and translation table 6. If a computer IP address and port number are found assigned to the temporary phone number the message server directs the message to the assigned IP address and port number.

If no IP address and port number are assigned to the temporary phone number the message server may send a message back to the mobile telecommunication device 12 advising that the message is undeliverable.

In the preferred embodiment, message server 4 looks up the temporary phone number using message database 5 and translation table 6. If a computer IP address and port number and receiving mobile telecommunication device number are found assigned to the temporary phone number the message server directs the message to the assigned IP address and port number.

If no IP address and port number and receiving mobile telecommunication device number are assigned to the temporary phone number the message server may send a message back to thee mobile telecommunication device 12 advising that the message is undeliverable.

Because any reply messages are sent to the web site accessed by the user and the computer IP address and port number a computer user must keep the web site open to receiving any incoming messages. A message to this effect may be displayed on the web site. Alternatively when the message server acknowledges that a message has been received it may also send a reminder to keep the web site open to receive any replies.

The foregoing describes the invention including a preferred form thereof Alterations and modifications as will be obvious to those skilled in the art and intended to be included in the scope hereof as defined by the accompanying claims.

1. A method of two-way communication between a web browser and a mobile telecommunication device including the steps of;
accessing a web-site via a computer,
sending a message to a mobile telecommunication device from the web-site, and
at a message server capturing the IP address and port number of the computer, assigning a temporary phone number to the IP address and port number of the computer, storing the temporary phone number, IP address of the computer and port number of the computer in a database, and sending the message to the mobile telecommunication device with the temporary phone number.

2. A method of two-way communication between a web browser and a mobile telecommunication device as claimed in claim 1 wherein a set number of temporary phone numbers are available for assigning by the message server.

3. A method of two-way communication between a web browser and a mobile telecommunication device as claimed in claim 1 or claim 2 further including the step of capturing the receiving mobile telecommunication device number at the message server.

4. A method of two-way communication between a web browser and a mobile telecommunication device as claimed in claim 3 further including the step of storing the receiving mobile telecommunication device number in the message server database.

5. A method of two-way communication between a web browser and a mobile telecommunication device as claimed in claim 4 wherein the temporary phone number is assigned based on the IP address and port number of the computer and the receiving mobile telecommunication device number.

6. A method of two-way communication between a web browser and a mobile telecommunication device as claimed in claim 1 or claim 2 the method further including the steps of;
at the message server receiving a message from a mobile telecommunication device sent to a temporary phone number of the message server, capturing the message and temporary phone number, using the database to match the temporary phone number to a computer IP address and port number, and sending the message to the computer with the matching IP address and port number.

7. A method of two-way communication between a web browser and a mobile telecommunication device as claimed in claim 6 further including the step of at the message server capturing the receiving mobile telecommunication device number.

8. A method of two-way communication between a web browser and a mobile telecommunication device as claimed in claim 7 further including the step of at the message server using the database to match the temporary phone number to a computer IP address and port number and to the receiving mobile telecommunications device number.

9. A method of two-way communication between a web browser and a mobile telecommunication device as claimed in any one of claims 1 to 8 further including the step of sending an acknowledgement message to the web browser when a message is received by the message server.

10. A method of two-way communication between a web browser and a mobile telecommunication device as claimed in any one of claims 1 to 9 further including the step of after the message server receives a message from the web browser the message server sends a message to the web browser informing the user of the web browser that to receive a response the web browser must remain open.

11. A message server arranged to;
capture an IP address and port number of a computer sending a message to a mobile telecommunication device via a web site,
capture the message sent by the computer,
assign a temporary phone number to the IP address and port number of the computer,
store the temporary phone number, IP address of the computer and port number of the computer in a database, and
send the message to the mobile telecommunication device with the temporary phone number.

12. A message server as claimed in claim 11 wherein the web site is provided by a telecommunication service provider.

13. A message server as claimed in claim 11 or claim 12 wherein a set number of temporary phone numbers are available for assigning by the message server.

14. A message server as claimed in any one of claims 11 to 13 wherein the message server is further arranged to capture the receiving mobile telecommunication device number.

15. A message server as claimed in claim 34 further arranged to store the receiving mobile telecommunication device number in the message server database.

16. A message server as claimed in claim 15 further arranged to assign the temporary phone number based on the IP address and port number of the computer and the receiving mobile telecommunication device number.

17. A message server as claimed in any one of claims 11 to 16 wherein the message server is further arranged so that upon receipt of a message from a mobile telecommunication device sent to a temporary phone number of the message server, it
captures the message and temporary phone number,
uses the database to match the temporary phone number to a computer IP address and port number, and
sends the message to the computer with the matching IP address and port number.

18. A message server as claimed in claim 17 further arranged to capture the receiving mobile telecommunication device number.

19. A message server as claimed in claim 18 further arranged to use the database to match the temporary phone number to a computer IP address and port number and the receiving mobile telecommunication device number.

20. A message server as claimed in any one of claims 11 to 19 further arranged to send an acknowledgement message to the web browser when a message is received by the message server.

21. A message server as claimed in any one of claims 11 to 20 further arranged to send a message to the web browser informing the user of the web browser that to receive a response the web browser must remain open after the message server receives a message from the web browser.
